(19) United States
(12) Patent Application Publication
(10) Pub. No.: US 2011/0194890 A1
(43) Pub. Date: Aug. 11, 2011

(54) QUICK FASTENING ASSEMBLY

(76) Inventor: Chien-Kuo Chang, Taichung City (TW)

(21) Appl. No.: 12/703,806

(22) Filed: Feb. 11, 2010

(51) Int. Cl. F16B 9/02

(52) U.S. Cl. 403/241

(57) ABSTRACT

A quick fastening assembly includes a connecting seat attached to a first object and having a connecting post, wherein the connecting post have one end fixedly combined with the connecting seat and an opposite end provided with a fastening end, that is linked to the connecting post via a movable joint. The quick fastening assembly further includes at least one reinforcing member attached to a second object, wherein the reinforcing member has a penetrating positioning hole while the second object is provided with a through hole aligned and intercommunicated with the positioning hole. Thereby, the connecting post is allowed to pass through the positioning hole and the through hole with the fastening end and the movable joint jutting out of the reinforcing member beyond the second object, so that the movable joint allows the fastening end to bend and thus fastens the first object and the second object together.

### BACKGROUND OF THE INVENTION

1. Technical Field

The present invention relates to a quick fastening assembly for connecting and positioning two external objects to be connected. More particularly, the quick fastening assembly is compact in structure and easy to operate without using any additional tool, thus being especially beneficial to combined furniture that needs frequent and prompt assembling and disassembling operation.

2. Description of Related Art

In crowded modern cities, living space is increasingly narrowed, and thus it is the trend that everything in the house has been downsized and multi-functioned in order to optimize people's indoor living quality. Particularly, the modern indoor appliances are expected to be versatile in applications, easy to store, and flexible in use. The conventional one-piece furniture, such as computer tables or office desks, is usually bulky and not collapsible, so is inconvenient and ponderous in package, storage and transportation.

In view of this, furniture designers have developed combined multi-piece furniture which is composed of components to be assembled by users with hand tools and screws so as to downsize furniture along package, storage and transportation. However, during assembly and disassembly of such known combined furniture, tools, such as screw drivers, are necessary, while complex and time-consuming operational steps have to be taken. Thus, the known approach is inconvenient and would be hindered once the necessary tools are unavailable or the screws are missed.

Another existing solution is to make furniture foldable. Nevertheless, folding structures may also require complicated, effort-consuming operation and time-consuming assembling or folding steps, thus being inconvenient as well. Some examples may be seen in Taiwan Patent No. M345529 “Collapsible Table”, Taiwan Patent No. M330775 “Improved Folding Table”, Taiwan Patent No. 1242421 “Overturn Mechanism for Table”, Taiwan Patent No. 556500 “Adjustment. Device for Table”, Taiwan Patent No. 538703 “Improvement of Folding Table”, Taiwan Patent No. 436197 “Folding Table”, Taiwan Patent No. 428448 “Folding Table Structure”, and Taiwan Patent No. 361144 “Folding Assembly for Conference Table”. All these folding structures become reversed T-shaped assemblies after folded or collapsed, and still take considerable space during package, storage and transportation. Besides, for achieving their respective functions, all these folding structures involve complex, numerous and heavy components, which are expensive and inconvenience in both manufacturing and assembling.

Hence, there is a need for providing a quick fastening assembly applicable to exiting folding and/or combined furniture. It shall be operated without using any tool and facilitating further downsizing current folding furniture and/or combined furniture after they are folded or taken apart for easy transportation or storage.

### SUMMARY OF THE INVENTION

For remedying the problems mentioned above, the present invention provides a quick fastening assembly, which is applicable to combined furniture so as to eliminate the need of both complicated combining components and time-consuming as well as effort-consuming assembling and disassembling operation.

To achieve the above and other objectives, the present invention provides a quick fastening assembly for connecting and positioning two external objects to be pivotally connected, the quick fastening assembly comprising: a connecting seat attached to one of the objects and provided with a connecting post, the connecting post having one end fixedly combined with the connecting seat and an opposite end formed with a fastening end, which is linked to the connecting post via a movable joint; and at least one reinforcing member attached to the other object and including a penetrating positioning hole, while the second object is provided with a through hole aligned and intercommunicated with the positioning hole; thereby, the connecting post being allowed to pass through the positioning hole and the through hole with the fastening end and the movable joint jutting out of the reinforcing member beyond the second object, and the movable joint allowing the fastening end to bend so as to fasten the first object and the second object together.

In use, the connecting seat and the reinforcing member are attached respectively to different components of combined furniture to be combined. The combined furniture may be a combined computer table. Thus, the quick fastening assembly of the present invention serves to fasten a first component (a main table board of the computer table) and a second component (a lateral board of the computer table) together by passing the connecting post on the first component (i.e. the main table board) through the positioning hole of the reinforcing member and a through hole of the second component ((i.e. the lateral board), and bending the fastening end jutting out of the reinforcing member in virtue of the movable joint, without using any additional tool so as to facilitate storage, transportation and assembly of the combined furniture.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a schematic view of a quick fastening assembly according to the present invention;

FIGS. 2, 3, 4 and 5 illustrate a first applied example of the quick fastening assembly; and

FIGS. 6 and 7 illustrate a second applied example of the quick fastening assembly.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

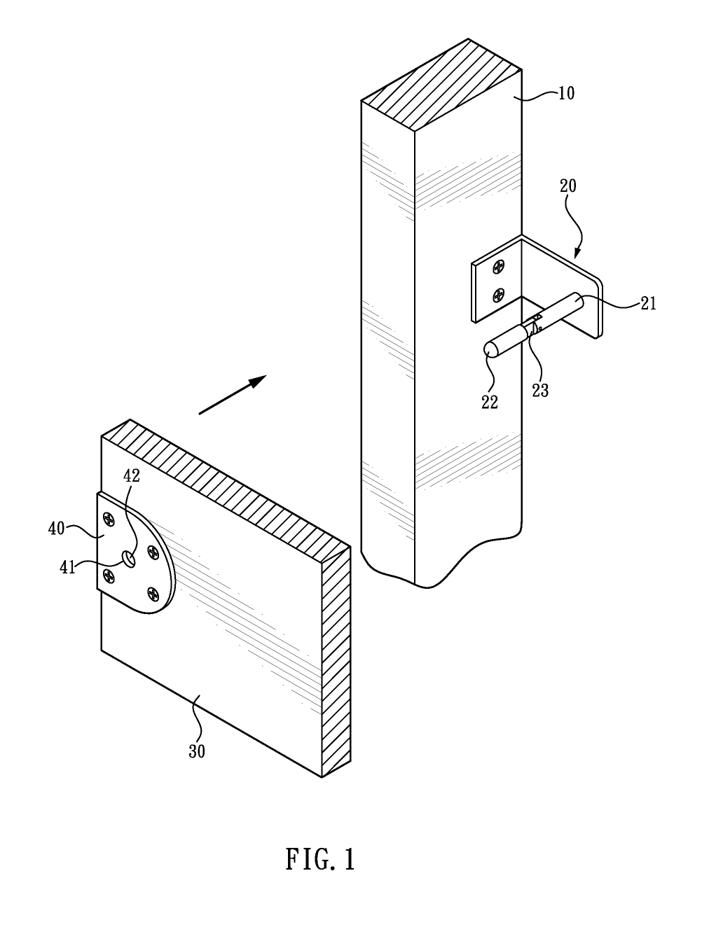

Referring to FIG. 1, the present invention provides a quick fastening assembly, which is mainly composed of a connecting seat 20 and at least one reinforcing member 40. The connecting seat 20 and the reinforcing member 40 are configured to be attached to a first object 10 and a second object 20 that need to be connected, respectively.

The connecting seat 20 is attached to the first object 10 and is substantially an L-shaped component comprising a fastening segment 201 and a connecting segment 202, wherein the fastening segment 201 and the connecting segment 202 are perpendicular mutually. The fastening segment 201 is provided with a plurality of threaded holes for allowing the fastening segment 201 to be screwedly fastened to the first object 10. The connecting seat 20 further has a connecting post 21, which has one end fixedly combined with the connecting seat 20 with an axis thereof perpendicular to a surface of the connecting segment 202. The connecting post 21 has its opposite end formed with a fastening end 22, which is connected to the connecting post 21 via a movable joint 23.

The at least one reinforcing member 40 is attached to the second object 30 and has a penetrating positioning hole 41. The second object 30 is also formed with a through hole 42 aligned and intercommunicated with the positioning hole 41. The reinforcing member 40 is provided with a plurality of threaded holes so as to allow the reinforcing member 40 to be screwedly fastened to the second object 30.

Thereby, when the connecting post 21 passes through the positioning hole 41 and the through hole 42, with the fastening end 22 and the movable joint 23 jutting out of reinforcing member 40 beyond the second object 30, the fastening end 22 can be bent in virtue of the movable joint 23 so as to fasten and position the first object 10 with respect to the second object 30.

Basing on the foregoing detailed structure, the operational principle of the disclosed quick fastening assembly will be given below.

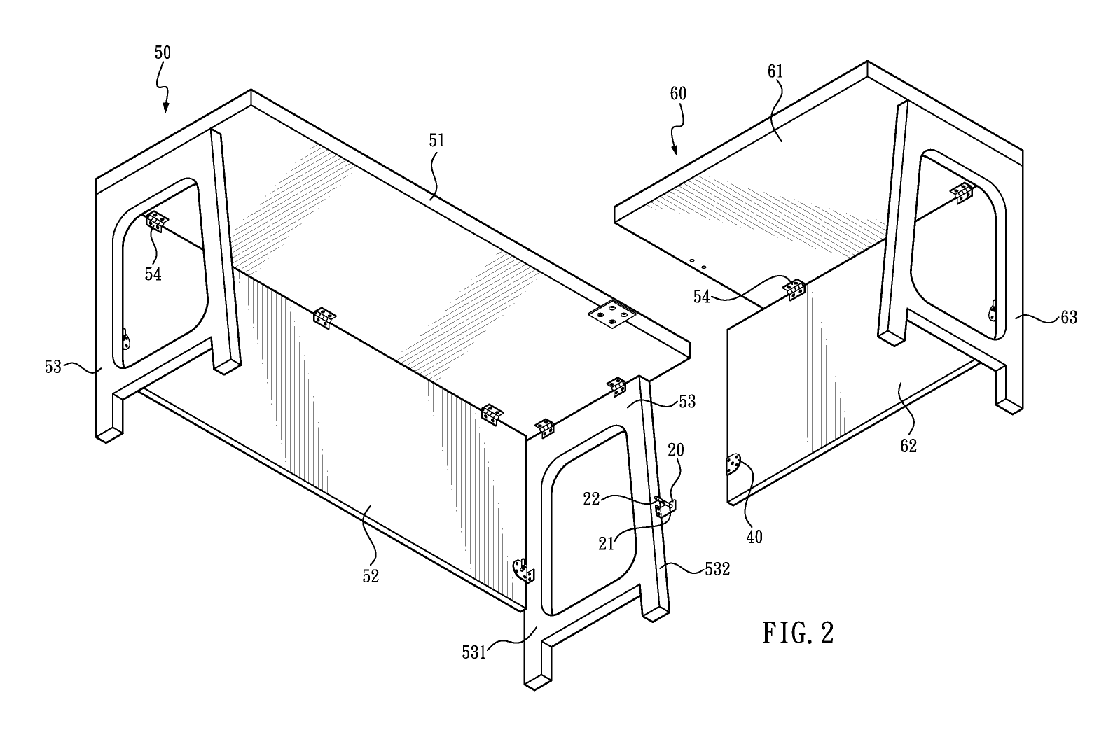

Please refer to FIG. 2 for an applied view of the quick fastening assembly of the present invention. As shown, the first object 10 may be a folding table 50, a table board 51, a lateral board 51 or a support plate 52 while the second object may be an auxiliary table 60, an auxiliary table board 61, an auxiliary lateral board 62 or an auxiliary support plate 63. The present invention is now applied to the folding table 50, which includes the table board 51, the lateral board 52 and at least one said support plate 53. The support plate 53 further includes at least one widthwise surface 531 and at least one depthwise surface 532. Conventional hinges 54 are used between the table board 51 and lateral board 52, as well as the table board 51 and the support plate 53 of the folding table 50, respectively. The hinges 54 allow the lateral board 52 and the support plate 53 to be successively folded and stored below the table board 51 of the folding table 50.

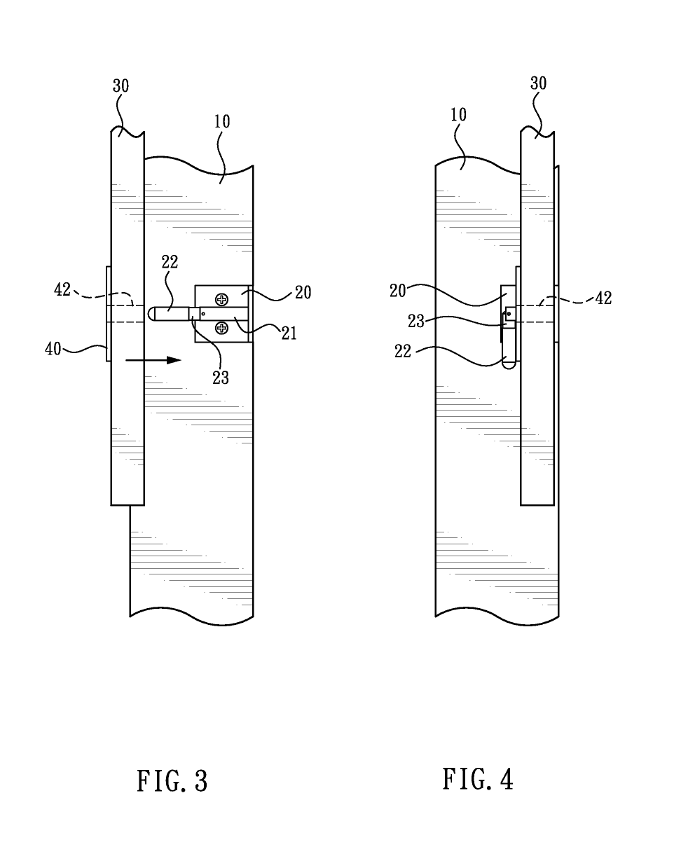

Please refer to FIG. 3 for the assembling procedure of the present invention. As shown in the drawing, the quick fastening assembly is now applied to the perpendicularly connected lateral board 52 and support plate 53 of the folding table 50, such as a desk or a computer table. The first object 10 is now the support plate 53, and the second object 30 is now the lateral board 52. The lateral board 52 and the support plate 53 of the folding table 50 are to be positioned as perpendicular to each other, namely including a 90-degree included angle therebetween. In assembly, the connecting seat 20 is attached to the widthwise surface 55 of the first object 10. The connecting seat 20 is screwedly attached to the first object 10. The fastening end 22 is able to bend laterally with respect to the connecting post 21 in virtue of the movable joint 23.

The reinforcing member 40 is attached to the second object 30, namely the lateral board. The reinforcing member 40 may be screwedly attached to the second object 30. The reinforcing member 40 has the positioning hole 31 passing therethrough, while the second object 30 has the through hole 32 aligned and intercommunicated with the positioning hole 31.

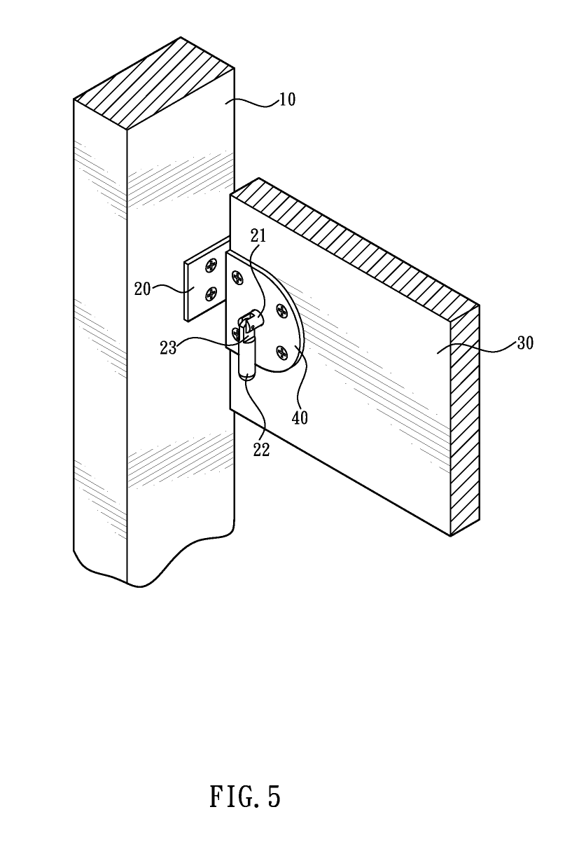

In assembly, the connecting post 21 pierces through the positioning hole 31 from one end and passes the through hole 32 to exit the positioning hole 31 at an opposite end thereof, so that the fastening end 22 and the movable joint 23 jut out of the reinforcing member 40 beyond the second object 30, allowing the fastening end 22 to bend in virtue of the movable joint 23. The movable joint 23 serves to make the bent fastening end 22 and the connecting segment 202 jointly sandwich and hold the second object 30. Please refer to FIG. 4 and FIG. 5 for the first object 10 and the second object 30 assembled by means of the quick fastening assembly. Therein, the movable joint 23 allows the fastening end 22 to bend and thereby connect the first object 10 and the second object 30. When it is desired to disassemble the first object 10 and the second object 30 assembled by means of the quick fastening assembly, the purpose can be easily achieved by unbending the fastening end 22 on the movable joint 23 and withdrawing them from the positioning hole 31 and the through hole 32.

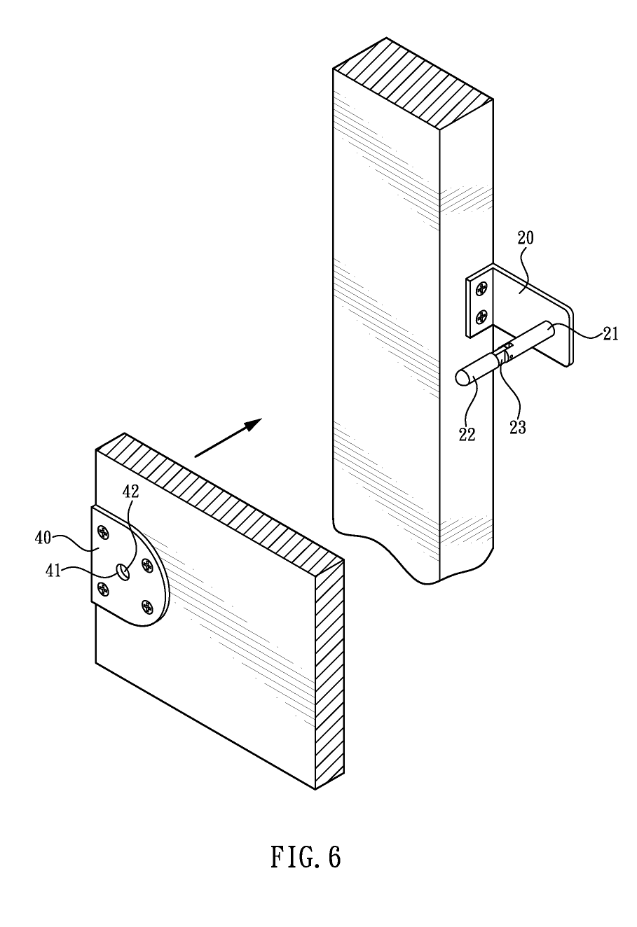

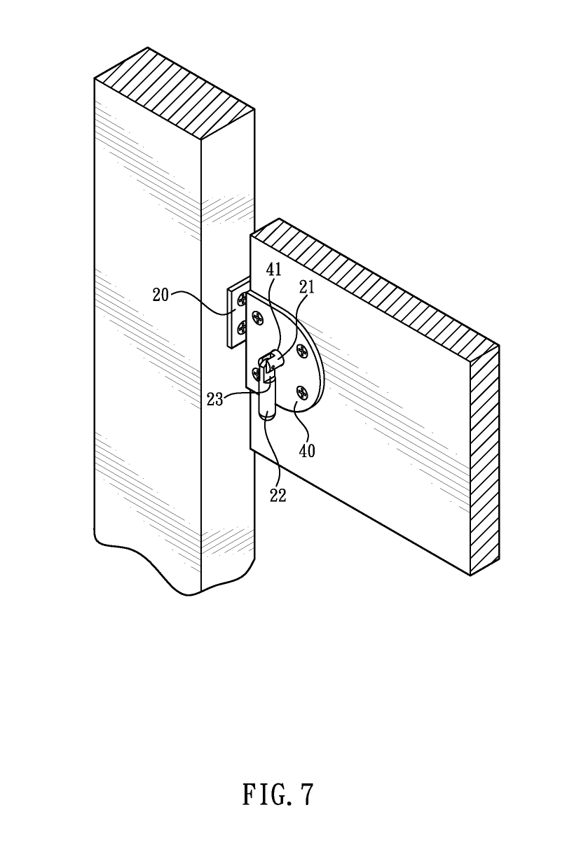

Referring to FIG. 6, the quick fastening assembly of the present invention is now used between the support plate 53 of the folding table 50 and the lateral board 62 of the auxiliary table 60 which are to be arranged as levelly adjacent to each other, namely including a 180-degree included angle therebetween. Therein, the connecting seat 20 is attached to the depthwise surface 56 of the first object 10. In assembly, the connecting post 21 pierces through the positioning hole 31 from one end and passes the through hole 32 to exit the positioning hole 31 at an opposite end thereof, so that the fastening end 22 and the movable joint 23 jut out of the reinforcing member 40 beyond the second object 30, allowing the fastening end 22 to bend in virtue of the movable joint 23. The assembled first object 10 and the second object 30 are shown in FIG. 7.

From the above, it is clear that the quick fastening assembly of the present invention includes merely simple components, and, when used in assembling or disassembling objects, requires no additional tool. By using the quick fastening assembly, objects are such assembled that they can be folded promptly and disassembled easily, without using any additional tool.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A quick fastening assembly applied to a first object and a second object for connecting and positioning the two external objects, the quick fastening assembly comprising:
a connecting seat attached to the first object and provided with a connecting post, the connecting post having one end fixedly combined with the connecting seat and an opposite end formed with a fastening end, which is linked to the connecting post via a movable joint; and
at least one reinforcing member attached to the second object and including a penetrating positioning hole, while the second object is provided with a through hole aligned and intercommunicated with the positioning hole;
thereby, the connecting post being allowed to pass through the positioning hole and the through hole so as to make the fastening end and the movable joint jut out of the reinforcing member beyond the second object, and the movable joint allowing the fastening end to bend so as to fasten the first object and the second object together.

2. The quick fastening assembly of claim 1, wherein the connecting seat is an L-shaped component.

3. The quick fastening assembly of claim 2, wherein the connecting seat includes a fastening segment and a connecting segment.

4. The quick fastening assembly of claim 3, wherein the fastening segment is provided with a plurality of threaded holes for allowing the fastening segment to be screwedly fastened to the first object.

5. The quick fastening assembly of claim 3, wherein the fastening segment and the connecting segment are perpendicular to each other.

6. The quick fastening assembly of claim 2, wherein the connecting post has an axis perpendicular to a surface of the connecting segment.

7. The quick fastening assembly of claim 1, wherein the reinforcing member is provided with a plurality of threaded holes for allowing the reinforcing member to be screwedly fastened to the second object.

8. The quick fastening assembly of claim 2, wherein the movable joint is configured to allow the fastening end that bends and the connecting segment jointly sandwich and hold the second object.

9. The quick fastening assembly of claim 1, wherein the reinforcing member is provided with a plurality of threaded holes for allowing the reinforcing member to be screwedly fastened to the second object.

10. The quick fastening assembly of claim 1, wherein the first and second objects are separate components belonging to a piece of combined furniture.
